(19) United States
(12) Patent Application Publication
(10) Pub. No.: US 2026/0061994 A1
(43) Pub. Date: Mar. 5, 2026

(54) Method for automatically moving a vehicle on private grounds as well as motor vehicle

(71) Applicants: CARIAD SE, Wolfsburg (DE); AUDI AG, Ingolstadt (DE)

(72) Inventors: Christian FEIST, Wolfsburg (DE); Reimund LIMBACHER, Ingolstadt (DE); Johannes GEHRET, Ingolstadt (DE); Benjamin SCHLIEWE, Ingolstadt (DE); Marcel EISBACH, Ingolstadt (DE)

(73) Assignees: CARIAD SE, Wolfsburg (DE); AUDI AG, Ingolstadt (DE)

(21) Appl. No.: 19/314,218

(22) Filed: Aug. 29, 2025

(30) Foreign Application Priority Data
Aug. 29, 2024 (DE) 10 2024 124 750.9

(51) Int. Cl. B60W 30/06; B60W 50/14; G01C 21/20

(52) U.S. Cl. CPC B60W 30/06; B60W 50/14; G01C 21/20; B60W 2050/146; B60W 2540/215; B60W 2556/40

(57) ABSTRACT

Automatically moving a vehicle based on defined sequences on private grounds, which are passed by the automatically moved vehicle one after the other. Thereby it is may be easier to perform automated driving.

### CROSS-REFERENCE TO RELATED APPLICATIONS

This application claims the priority benefit of German Patent Application No. 10 2024 124 750.9 filed on Aug. 29, 2024, which is incorporated by reference herein in its entirety.

### BACKGROUND

### 1. Field

An invention relates to a method for automatically moving a vehicle on private grounds and to a motor vehicle configured for performing the method.

### Description of the Related Art

Already heretofore, it is usual to cause parking operations and exiting operations to be automatically performed by a motor vehicle on private grounds. Herein, the motor vehicle typically passes trained paths.

From WO 2022/180 005 A1, a method for at least partially automated parking of a motor vehicle based on an overview map of grounds is known: Objects on the grounds are classified to the effect if they are passable or not passable, and non-passable objects are marked as obstacles in the overview map. With the aid of this information, an already planned trajectory known per se can be changed.

WO 2017/118 546 A1 discloses a method for repetitive parking into a parking area. In first parking, environmental information of the parking area is captured. Movable and immovable objects are distinguished. The user can select objects and store information thereto, which can be retrieved upon later parking.

### SUMMARY

An example object of the invention may be to allow a more flexible automated movement of a vehicle on private grounds.

The example object may be solved by a method and motor vehicle with features according to the claims.

The method according to the examples of the invention for automatically moving a vehicle on private grounds may include presetting a destination on the private grounds and at least one intermediate destination on the private grounds to be reached on the way to the destination by a user (i.e. receiving a user input, which presets the destination and the at least one intermediate destination); and by using a map relating to at least a partial area of the private grounds, automatically guiding the vehicle over the at least one intermediate destination to the destination.

In that automatically guiding the vehicle first to the intermediate destination, then optionally to a further intermediate destination and finally to the destination is effected in the method, thus, that a concatenation is effected in at least two stages, shorter trajectories can be planned and herein map information can be more reliably used in automatically moving the vehicle. This can in particular result in the fact that the vehicle plans its trajectory ad hoc by itself in the automated movement on the private grounds in that data is continuously or repeatedly newly captured by sensors of the vehicle and the drive to the next intermediate destination or to the ultimate destination is correspondingly effected.

According to an example of the invention, the map registers (“includes”) an indication of at least one obstacle for the vehicle on the private grounds and/or at least one prohibited zone for the vehicle, and this indication is used in automatically guiding. By heading for the destination effected at least in two stages over the at least one intermediate destination, thus the mentioned concatenation, bypassing the obstacles or avoiding a prohibited zone on the private grounds is facilitated without a trajectory having to be already planned in advance. The vehicle can in particular, as mentioned above, plan the drive due to sensor signals while it drives.

According to an example, the map is displayed to the user on a display device at least in certain areas and the user can perform the presetting of destination and at least one intermediate destination via an input device. Thereby, a flexible planning is allowed to the user. The at least one intermediate destination and the destination can be referred to as accurate to pixel or else also be defined by indication of smaller partial surface areas on the private grounds, which are less than the entire passable surface of the private grounds by a certain factor (at least 5, for example 10, 20, or 50). This means that the accuracy of the indication of destination and intermediate destination is high such that the user has actually a choice. This is in particular advantageously possible if the vehicle plans its drive on the private grounds during driving and does not have to follow a preset trajectory. The example is in particular reasonable in connection with the display also of the obstacles on the map via the display device because the user can then plan intermediate destinations and destination based on the registered obstacles such that the vehicle can safely move on the private grounds and can herein easily bypass the obstacles.

According to an example, the display device and/or the input device are part of the vehicle. In this manner, the user, who wishes to have the vehicle park autonomously, can plan the parking as long as the user is still sitting in the vehicle. Exiting the vehicle can also only be provided at a certain intermediate destination. The display device and/or the input device can also be realized separately from the vehicle, for example by a smartphone, a smart watch or another movable operating device.

According to an example of the method, the initial generation of the map also belongs to the method. Principally, this can occur such that present construction plans or architectural sketches are digitized and/or that professional measurement equipment such as for instance laser measurement devices is used, wherein a provided service can dispatch specialists on site. Alternatively or additionally, a certain application for mobile terminals like smartphones and smart watches can be used, which uses the sensor technology of the mobile terminal for capture.

According to an example, however, the map is generated by driving on, for example completely driving on, the drivable parts of the private grounds (in a special recording mode, which may use the sensor technology of the vehicle for capture), wherein data is recorded, which precisely may be derived from the sensor technology of the vehicle (whereto a position measuring device such as for instance a GPS (Global Positioning System) sensor can also be used among other things). Upon completely driving, it can in particular also be taken into account, which locations in principle are not involved in a parking operation (because they could optionally once be provided at a later point of time as an intermediate destination due to an obstacle).

In generating the map, the drivable surface, static obstacles like walls, columns etc. and also slopes, inclinations, plane transitions and the like can be captured among other things. Distinctive features can be detected for later guidance, for instance texture boundaries, signs, illumination, bricks, striping, drain grates, rain gutters and the like.

In driving on the surface, it should optionally also be captured where the private grounds end in order that the vehicle does not unintentionally autonomously drive to the neighboring grounds. In the area of a garden pond and the like, a prohibited zone can be defined. During generation of the map, in particular during driving, but optionally also subsequently, an indication of obstacles and/or prohibited zones can be registered based on inputs by a person, if the sensor technology of the vehicle is not used here.

According to an example, in particular after the initial capture, a user-friendly interface (for example in the application on the mobile terminal or in the browser, which runs on a personal computer or the like) can be offered to the user such that a digital annotation of the previously captured environmental data is allowed. Thus, the user can perform further annotations in addition to the data optionally captured based on sensor technology, also optionally change present measurement results or increase or decrease an associated stage of importance. Thus, the user can mark areas by his annotation, into which the vehicle is not allowed to navigate at all (for instance if such areas are difficultly or not visible by the vehicle sensor technology). The user can mark areas with increased potential of risk by not necessarily static objects, like areas, in which the children usually play, where sports equipment, gardening tools can be or are deposited, vegetation is present, etc. The user can define local destination areas for the function (parking spaces, buffer spaces, entrances/exits to the private grounds, charging possibilities for electric vehicles etc.). The user can also mark such monitorable areas, in which a driverless operation of the function can be enabled, wherein the monitoring can be effected immediately, directly, or by mirrors or digital sensor technology, thus indirectly. The user can preset suitable areas and required information for controlling infrastructure technology such as for instance home automation. He can also mark areas, where an action guideline is given (for instance: that the motor vehicle is to maintain distances, is not to exceed a certain speed, is to drive an accurate track, is not to steer at stop etc.). Finally, the user can highlight invariable distinctive features for later guidance.

According to an example, upon reaching at least one intermediate destination and/or the destination, actuators internal to vehicle not related to the driving movement and/or actuators external to vehicle can be automatically activated by the vehicle. An example for actuators internal to vehicle can relate to the vehicle doors. Thus, the door can be automatically opened at an intermediate destination in order that the user can exit the vehicle at the intermediate destination. The trunk lid could optionally also be opened in order that the user can unload at his doorstep before the vehicle moves from the intermediate destination further to the next intermediate destination or optionally to the destination. Actuators external to vehicle can relate to a gate (garden gate, garage gate).

In the step of presetting or in a separate step, a dedicated approval of the movement free space for the vehicle can advantageously be effected by the user. Thus, technical and legal problems can be avoided, which can be associated with the definition of areas captured in completely automated manner; in particular, it can be ensured by the user that the vehicle does not leave the own private grounds and drives on other private grounds.

The partial routes for example from an entry zone to the private grounds to a first intermediate destination and the partial routes between intermediate destinations, optionally also in multiple combinations of intermediate destinations, can be stored in advance, such that sequences (“routines”) arise, which the vehicle executes in order upon retrieval (by presetting within the scope of the method). Therein, the components in the sequences include among others:
the heading for a parking space, loading place, towards an exit, this associated with action guidelines to the vehicle like entry direction, distances to be maintained, etc. ;
turning/direction change (here, the intermediate destination would be assigned twice in a way: The vehicle first drives to the intermediate destination, then turns, and again drives to the intermediate destination, now with different orientation);
stopping/waiting for a specified period of time (for instance for three minutes in order that the user can exit, or for a longer time for unloading the trunk or also for a period of time, which is defined by actions; for instance also: closing the trunk causes the vehicle to retrieve and pass the next sequence);
the mentioned control of functions internal to vehicle can further be extended by the control of functions external to vehicle like infrastructure function, online services etc., wherein barriers and gates can be opened and closed, etc. ;
control of charging functions (activating an inductive bottom plate or a robot arm of an electrical charging station, which connects a vehicle stopped at the charging station to the charging station);
exchanging the parking position of multiple vehicles.

It can be essential that not only the map as such, but the annotated previous knowledge on drivable and allowed areas is automatically used such that static obstacles are bypassed.

According to an example, a continuous information to the user about the function progress is effected, wherein the vehicle can for example deliver a current location, for example related to the map, via which the presetting may have already been effected, to the user. This can be effected in the vehicle interior for the user remaining in the vehicle or also via the application to a mobile terminal (smartphone, smart watch or the like).

The motor vehicle according to the examples of the invention includes a control device for automatically moving the vehicle on private grounds and is characterized by an input device, via which both a destination on private grounds and an intermediate destination to be passed on the way to the destination can be preset to the motor vehicle by a user, for example in relation to a map representation displayed on a display device of the motor vehicle.

In this aspect too, the invention according to the examples realizes the operation of a concatenation of at least one intermediate destination to the destination such that sequences can be passed on the private grounds. By such an allowed granularity in the route sections, obstacles can be reliably bypassed. According to an example of the motor vehicle, tasks can also be preset via the input device, which are directed to actuators internal to vehicle not related to the vehicle movement and/or to actuators external to vehicle. Hereto, it was already mentioned that the motor vehicle is to automatically open certain doors at a stop, or that gates or the like are opened for the motor vehicle or also later again closed.

For application cases or application situations, which can arise in the method and which are not explicitly described here, it can be provided that an error message and/or a request for inputting a user feedback are output and/or a default setting and/or a predetermined initial state are adjusted according to the method.

The control device for the motor vehicle also belongs to the invention according to the examples. The control device can comprise a data processing device or a processor device, which is configured to perform the method according to the examples of the invention. Hereto, the processor device can comprise at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can respectively be used as the microprocessor. Furthermore, the processor device can comprise a program code, which is configured to perform the method according to the examples of the invention upon execution by the processor device. The program code can be stored in a data memory of the processor device. The processor device can e.g. be based on at least one circuit board and/or on at least one SoC (System on Chip).

Developments of the motor vehicle according to the examples of the invention, which comprise features, as they have already been described in context of the developments of the method according to the examples of the invention, also belong to the invention. For this reason, the corresponding developments of the method according to examples of the invention are not again described here.

The motor vehicle according to the examples of the invention may be configured as a car, in particular as a passenger car or truck, or as a passenger bus or motorcycle.

As a further solution, the invention according to the examples also includes a computer-readable storage medium including program code, which, upon execution by a computer or a computer cluster, causes it to execute the method according to the examples of the invention. The storage medium can be at least partially provided as a non-volatile data memory (e.g. as a flash memory and/or as an SSD—solid state drive) and/or at least partially as a volatile data memory (e.g. as a RAM—random access memory). The storage medium can be arranged in the computer or computer cluster. However, the storage medium can for example also be operated as a so-called Appstore server and/or Cloud server in the Internet. By the computer or computer cluster, a processor circuit with for example at least one microprocessor can be provided. The program code can be provided as a binary code and/or as an assembler code and/or as a source code of a programming language (e.g. C) and/or as a program script (e.g. Python).

The invention according the examples also includes the combinations of the features of the described examples. Thus, the invention according to the examples also includes realizations, which each comprise a combination of the features of multiple of the described examples, if the examples have not been described as mutually exclusive.

### BRIEF DESCRIPTION OF DRAWINGS

In the following, examples of the invention are described. Hereto, there shows:

FIG. 1 is a map representation as it can be usable by the motor vehicle according to an example of the invention within the scope of a method;

FIG. 2 is a flow diagram for illustrating steps of the method according to the example of the invention; and

FIG. 3 is schematically components of a motor vehicle according to an example of the invention.

### DESCRIPTION

The execution examples explained in the following are examples of the invention. In the execution examples, the described components of the examples each represent individual features of the examples of the invention to be considered independently of each other, which also each develop the examples of the invention independently of each other. Therefore, the disclosure also is to include combinations of the features of the examples different from the illustrated ones. Furthermore, the described examples can also be supplemented by further ones of the already described features of the examples of the invention.

In the figures, identical reference characters each denote functionally identical elements.

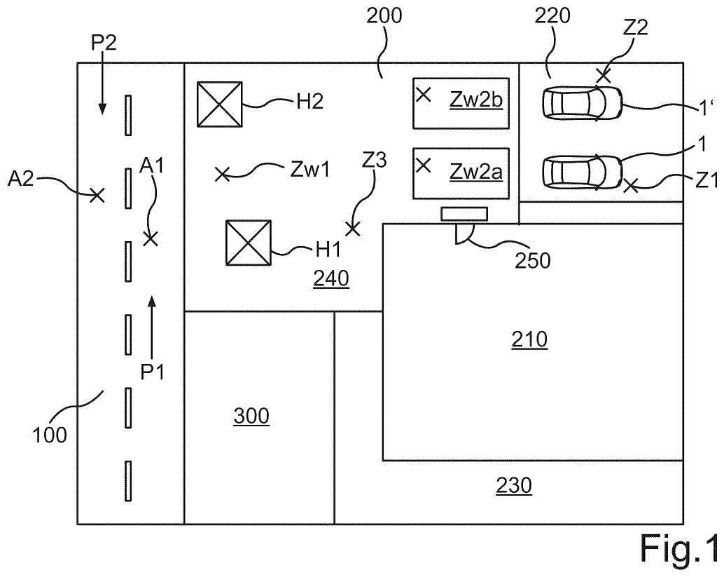

A map shown in FIG. 1 shows a public road 100 as well private grounds 200 and neighbor grounds 300 adjoining thereto. The private grounds 200 include a house 210, a garage 220, a garden surface 230 and a yard 240. The motor vehicles 1 and 1′ to be parked in the garage 220 can drive on the yard 240, before they enter the garage 220. A first obstacle H1, which can for example represent a tree, and a second obstacle H2, which can for example represent a tool shed or the like, are annotated in the map. The user of the motor vehicle wishes to park the motor vehicle from an initial position, for example when the user drives on the public road 100 according to the arrow P1 up to the point A1, in the garage on the destination Z1 or the destination Z2. If the user drives in the opposite direction according to the arrow P2, the beginning A2 for automatically parking can be on the other side of the road. The user can preset certain intermediate destinations, over which the destinations Z1, Z2 are to be reached. A first intermediate destination Zw1 can be between the obstacles H1 and H2 and be defined in order that the autonomously parking vehicle does not arrive at the obstacles H1 and H2. In the present example, the intermediate destination Zw1 is an intermediate destination, which is passed independently of whether the destination Z1 or Z2 is to be reached. It would also be possible to provide here two separated intermediate destinations, which are spaced from each other.

The motor vehicle 1, which is to reach the destination Z1 in the garage 220, is to first reach the intermediate destination Zw2a after the intermediate destination Zw1. There, it is in front of the entrance 250 into the house 210, such that an unloading operation can for instance be effected. Here, it can be provided that a longer stop is effected upon reaching the intermediate destination ZW2a before the vehicle 1 is autonomously further parked into the garage to the destination Z1.

For the motor vehicle 1′, which is to reach the destination Z2, the intermediate destination Zw2b is provided after the intermediate destination Zw1.

An example of the method according to the invention explained below includes two step sequences, namely the step sequence Sf1, in which a map like that shown in FIG. 1 is generated, and the step sequence Sf2. The method according to the examples of the invention can already be realized by the step sequence Sf2 alone, but may be effected in combination with the step sequence Sf1.

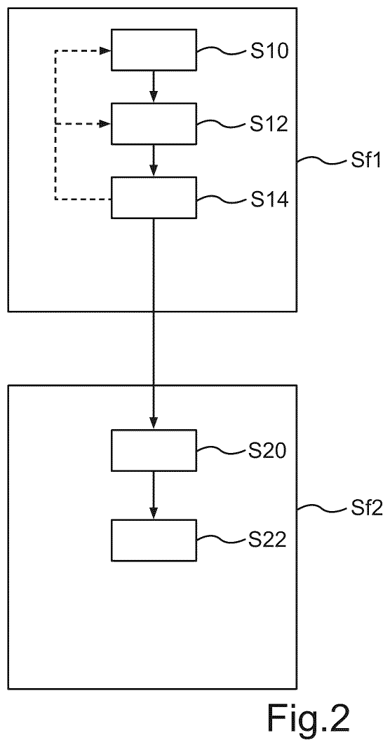

In step S10 within the scope of the step sequence Sf1, a motor vehicle starts to drive on the grounds. Herein, a user may be sitting in the motor vehicle and systematically drives over the grounds 200. In the example of the private grounds 200 from FIG. 1, the user would for instance drive over all of the corners of the yard 240 and also the garage 220. During driving or subsequently, optionally after driving sections, presenting the captured data on a display device, which is provided to the user, is effected in step S12. It can be a display device of the vehicle, with which it is driven over the grounds 200, or by the motor vehicle, which is used for driving, data can be transmitted to a mobile device of the user (smartphone, smart watch or the like). In step S14, the user can annotate the already arising or arisen map via an input device (which for instance coincides with the output device in case of use of a touchscreen), for example perform the marking of the obstacles H1 and H2, as shown in FIG. 1. The steps S10, S12 and S14 can also be newly effected again and again, which is illustrated by the dashed arrows in FIG. 2: From step S14, it is optionally returned to step S10 or at least to step S12.

Now, after the map with the annotations is finally provided, a transition to the step sequence Sf2 is effected. In this case, the annotated map is used, namely for automatically moving the motor vehicle 1 or 1′ on the grounds 200. The motor vehicle 1 or 1′ does not have to be identical to the motor vehicle, which has previously driven over the grounds for generating the map. In the step S20, the user can preset a destination (for instance the destination Z1 for the motor vehicle 1) and intermediate destinations (for instance Zw1 and Zw2a) on an input device (for example in the motor vehicle itself). The user can do this long before or only upon reaching the point A1 or A2, thus if the user wishes to begin the parking operation. In step S22, autonomously driving the vehicle onto the private grounds 200 to the mentioned destination over the mentioned intermediate destinations is now effected, wherein a pretrained trajectory may not be used here, but sensors newly provide information to the vehicle again and again.

The operations can also be flexible overall, for example, there can be a third destination Z3 on the grounds, which is to be reached by one of the vehicles 1 or 1′. In this case, reverse parking on the yard besides the house 210 would be provided after the intermediate destination Zw2a or Zw2b.

The method according to the examples of the invention and in particular the step sequence Sf2 can also relate to exiting a parking space or the user can also provide both a parking and an exiting operation in combination within the scope of the method, optionally also only partially at least one of parking and exiting operation.

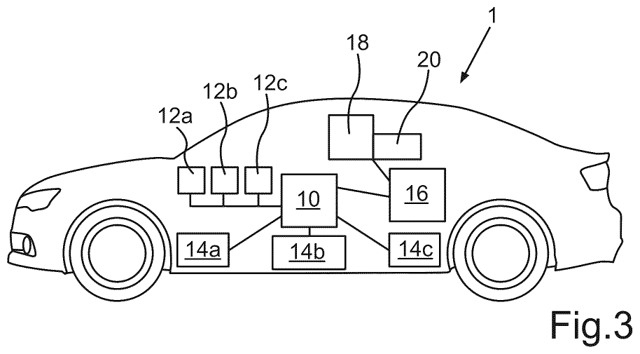

The motor vehicle 1 shown in FIG. 3 according to an example of the invention includes a (for example central) control device 10 for automatically moving the vehicle on private grounds, whereto signals of sensors 12a, 12b, 12c etc. are used and signals are emitted to actuators 14a, 14b, 14c. Presently, the map with annotations generated in the step sequence Sf1 or similar is stored in a memory 16 of the motor vehicle, and it is presented to the user on a display device 18 of the vehicle, who can then preset the destination (Z1, Z2, Z3 or any other) and intermediate destinations Zw1, Zw2a, Zw2b, etc. via an input device 20.

Within the scope of the method, it can be provided that the destinations and intermediate destinations shown on the map as in FIG. 1 have already been set once before and are already stored, this in the memory 16. However, it can also be that a new destination is generated, for example instead of the destination Z1 in the garage 220 and the destination Z2 in the garage 220, it can be provided that only a single vehicle parks in the middle-for instance if bicycles and the like are present in the garage.

The invention according to the examples introduces the concept to ascertain information to the private grounds instead of a trained path and thus to train the grounds to the vehicle in a way, wherein it can then be more flexibly driven on the grounds.

Overall, the examples show, how scalable automated parking functions for private grounds can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of automatically moving a vehicle on private grounds, comprising:
by a processor,
presenting, on a display device, a map relating to at least a partial area of an area of the private grounds and configured for presetting a destination on the private grounds and at least one intermediate destination on the private grounds to be reached on way to the destination; and
using the map in automatically guiding the vehicle over the at least one intermediate destination to the destination.

2. The method according to claim 1, wherein the map is configured to record, based on the presetting, an indication of at least one obstacle for the vehicle on the private grounds and/or a prohibited zone for the vehicle, such that the indication is used in the automatically guiding.

3. The method according to claim 1, wherein the map is displayed to a user on the display device for at least the partial area, such that the user performs the presetting of the destination and the at least one intermediate destination via an input device.

4. The method according to claim 3, wherein the display device and/or the input device is or are a part of the vehicle.

5. The method according to claim 1, wherein the map is initially generated for the presenting of the map.

6. The method according to claim 5, wherein the map is generated based on driving on drivable parts of the private grounds to record data related to the area of the private grounds.

7. The method according to claim 6, wherein obstacles and/or prohibited zones are captured by sensor technology of the vehicle and/or based on inputs by a person during the driving.

8. The method according to claim 1, wherein upon reaching the at least one intermediate destination and/or the destination, actuators internal to vehicle not related to a driving movement of the vehicle and/or actuators external to vehicle are automatically activated by the vehicle.

9. A motor vehicle with a control device configured to automatically move the motor vehicle on private grounds, comprising:
an input device, via which both a destination on the private grounds and at least one intermediate destination to be passed on a way to the destination are preset to the motor vehicle by a user, in relation to a map representation displayed on a display device of the motor vehicle, such that the control device is configured to use the map in automatically guiding the motor vehicle over the at least one intermediate destination to the destination.

10. The motor vehicle according to claim 9, wherein tasks are preset via the input device, the tasks directed to actuators internal to the motor vehicle not related to a movement of the motor vehicle and/or to actuators external to the motor vehicle.
